(19) United States
(12) Patent Application Publication
(10) Pub. No.: US 2025/0085484 A1
(43) Pub. Date: Mar. 13, 2025

(54) OPTICAL-FIBER CONNECTOR

(71) Applicant: ACON OPTICS COMMUNICATIONS INC., New Taipei City (TW)

(72) Inventors: Jia-Rong Wu, New Taipei City (TW); Tsung-Yao Hsu, New Taipei City (TW)

(21) Appl. No.: 18/826,781

(22) Filed: Sep. 6, 2024

(30) Foreign Application Priority Data
Sep. 11, 2023 (TW) 112209798

(51) Int. Cl. G02B 6/38

(52) U.S. Cl. CPC G02B 6/387; G02B 6/3839; G02B 6/3893

(57) ABSTRACT

An optical-fiber connector includes a first metal housing, a second metal housing, and a plurality of coupling components, where the first metal housing and the second metal housing are assembled with each other. The first metal housing has a receiving space. Two ends of the first metal housing respectively include a plurality of first mating portions and a first tail cap assembling portion. Two ends of the second metal housing respectively include a plurality of second mating portions corresponding to the first mating portions and a second tail cap assembling portion assembled with the first tail cap assembling portion. Each of the coupling components includes a coupling body and a metal stopping member. Each of the coupling bodies has a positioning portion. Each of the positioning portions is assembled with a corresponding one of the first mating portions and a corresponding one of the second mating portions.

### CROSS-REFERENCE TO RELATED APPLICATION

This non-provisional application claims priority under 35 U.S.C. § 119 (a) to patent application Ser. No. 11/220,9798 filed in Taiwan, R.O.C. on Sep. 11, 2023, the entire contents of which are hereby incorporated by reference.

### FIELD OF THE INVENTION

The instant disclosure relates to a connector, and more particular to an optical-fiber connector.

### BACKGROUND

The optical fiber is an tool for optical transmission. An optical-fiber connector is used for connecting the optical fiber with different electronic devices, so that the electronic devices can utilize the signals transmitted by the optical fiber. An optical-fiber connector known to the inventor includes a housing and flexible arms on the housing. The housing and the flexible arms are formed as a one-piece structure which is made of plastic. Because the housing and the flexible arms are made of plastic, the structural strength of these components are insufficient. As a result, after the flexible arms are bent for a period of time, the flexible arms may be broken easily.

### SUMMARY OF THE INVENTION

In view of these, some embodiments of the instant disclosure provide an optical-fiber connector having upper and lower metal housings and having a metal stopping member.

According to some embodiments, an optical-fiber connector is provided and comprises a first metal housing, a second metal housing, and a plurality of coupling components. The first metal housing has a receiving space, one of two ends of the first metal housing comprises a plurality of first mating portions in communication with the receiving space, and the other end of the first metal housing has a first tail cap assembling portion. The second metal housing covers the first metal housing, one of two ends of the second metal housing comprises a plurality of second mating portions corresponding to the first mating portions, and the other end of the second metal housing comprises a second tail cap assembling portion correspondingly assembled with the first tail cap assembling portion. Each of the coupling components comprises a coupling body and a metal stopping member extending outwards from a surface of the coupling body, a side end of each of the coupling bodies comprises a positioning portion, and each of the positioning portion is assembled with a corresponding one of the first mating portions and a corresponding one of the second mating portions.

In some embodiments, each of the coupling components comprises a core component and a plug, the coupling body has a through hole, the core component is in the through hole, the plug comprises two flexible arms, each of the flexible arms has a hook portion, the coupling body has a plurality of engaging holes at an inner wall of the through hole, each of the flexible arms is placed in the through hole, and each of the hook portions is engaged with a corresponding one of the engaging holes. For each of the coupling components, the core component comprises an insertion pin and an elastic member fitted over the insertion pin, and the plug is at an opening of the through hole and abuts against the elastic member.

In some embodiments, each of the first mating portions has a first recess and a first positioning groove at each of two sides of the first recess, each of the positioning portions comprises an extension block and a positioning block at each of two sides of the extension block, and each of the positioning blocks is engaged with a corresponding one of the first positioning grooves. The first recess is rectangular or arced, in response to that the first recess is rectangular, the extension block is a square structure corresponding to the first recess being rectangular; in response to that the first recess is arced, the extension block is a round structure corresponding to the first recess being arced.

In some embodiments, each of the second mating portions has a second recess corresponding to the first recess and assembled with the corresponding one of the positioning portions; the second recess is rectangular or arced, in response to that the first recess is rectangular, the second recess is rectangular corresponding to the first recess being rectangular; in response to that the first recess is arced, the second recess is arced corresponding to the first recess being arced.

In some embodiments, each of two sides of the first metal housing has a positioning post, the first metal housing comprises a first locking portion in the receiving space, each of two sides of the second metal housing has a positioning hole, the second metal housing comprises a second locking portion, each of the positioning posts is mated with a corresponding one of the positioning holes, and the first locking portion is mated with the second locking portion. The first metal housing comprises a plurality of partition portions in the receiving space, and the partition portions are at the two sides of the first locking portion.

In some embodiments, the optical-fiber connector further comprises a pressing member. The pressing member has a partition plate and a pressing portion, each of two sides walls at two sides of the first metal housing has an engaging groove, two ends of the partition plate are respectively engaged with the engaging grooves, the partition plate has a plurality of slots corresponding to the first mating portions, a top portion of each of the slots is adjacent to a top portion of a corresponding one of the two sides walls of the first metal housing, and each of the two ends of the partition plate has a shoulder portion exposed from a corresponding one of the engaging grooves. The second metal housing has an assembling hole, and the pressing portion is exposed from the assembling hole and abuts against the metal stopping members.

In some embodiments, each of the two sides of the first metal housing has a mating protrusion, each of two sides of the second metal housing has a mating recess, each of the mating protrusions is mated with a corresponding one of the mating recesses, a lower surface of the second metal housing has a plurality of limiting grooves, and each of the shoulder portions of the pressing member is engaged with a corresponding one of the limiting grooves.

In some embodiments, the lower surface of the second metal housing comprises a plurality of stopping blocks, and each of the stopping blocks is between a corresponding one of the second mating portions and a corresponding one of the limiting grooves.

In some embodiments, the first tail cap assembling portion comprises a first semicircle socket structure, the second tail cap assembling portion comprises a second semicircle socket structure, the first semicircle socket structure is mated with the second semicircle socket structure, the optical-fiber connector further comprises a compression ring and a tail cap, the compression ring is fitted over the first semicircle socket structure and the second semicircle socket structure, and the tail cap is fitted over the compression ring.

In some embodiments, for each of the coupling components, an upper surface of the coupling body has a first horizontal plane, an upper surface of the second metal housing has a second horizontal plane, the second horizontal plane is higher than the first horizontal plane and adjacent to a side end of the metal stopping member, and the side end of the metal stopping member is adapted to lean against the second horizontal plane.

According to some embodiments of the instant disclosure, through the configuration that the first metal housing and the second metal housing are made of metal, the optical-fiber connector can have a robust structure and damages of the connector can be prevented, thereby extending the service life of the optical-fiber connector. Moreover, according to some embodiments, the plug is fixed with the through hole of the coupling body and abuts against the elastic member, so that the elastic member can be properly limited within the through hole. Furthermore, according to some embodiments, several types of combinations among the coupling body, the first metal housing, and the second metal housing or combinations between the first metal housing and the second metal housing can be achieved, thereby the optical-fiber connector can be utilized in different applications.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of an optical-fiber connector according to some embodiments of the instant disclosure, where the first metal housing is locked with the second metal housing;

FIG. 2 illustrates a front exploded view of the optical-fiber connector according to some embodiments of the instant disclosure, where internal elements of the coupling component is not exploded;

FIG. 3 illustrates a rear exploded view of the optical-fiber connector according to some embodiments of the instant disclosure, where internal elements of the coupling component is not exploded;

FIG. 4 illustrates an exploded view of the coupling component according to some embodiments of the instant disclosure;

FIG. 5 illustrates a perspective view of the coupling component according to some embodiments of the instant disclosure, where the positioning portion of the coupling body is a square structure;

FIG. 6 illustrates a cross-sectional view of the coupling component according to some embodiments of the instant disclosure;

FIG. 7 illustrates an assembling perspective view of the first metal housing and the coupling component according to some embodiments of the instant disclosure, where the square positioning portion of the coupling body is engaged with the first recess of the first mating portion;

FIG. 8 illustrates a perspective view of a pressing member assembled on the first metal housing according to some embodiments of the instant disclosure;

FIG. 9 illustrates a perspective view of the second metal housing according to some embodiments of the instant disclosure, where the second metal housing comprises a second locking portion and the second mating portion is rectangular;

FIG. 10 illustrates a perspective view of the second metal housing according to some embodiments of the instant disclosure, where the second metal housing comprises a second locking portion and the second mating portion is arced;

FIG. 11 illustrates a front perspective view of the optical-fiber connector according to some embodiments of the instant disclosure, where the second metal housing comprises a second locking portion and the optical-fiber connector does not comprise a pressing member;

FIG. 12 illustrates a rear perspective view of the optical-fiber connector according to some embodiments of the instant disclosure, where the first metal housing comprises a first locking portion and a screw is locked to the first locking portion;

FIG. 13 illustrates a front exploded view of the optical-fiber connector according to some embodiments of the instant disclosure, where the first metal housing comprises a first locking portion and the first metal housing has a plurality of partition portions in the receiving space;

FIG. 14 illustrates a rear exploded view of the optical-fiber connector according to some embodiments of the instant disclosure, where the first metal housing comprises a first locking portion and the first metal housing has a plurality of partition portions in the receiving space;

FIG. 15 illustrates a perspective view of an optical-fiber connector according to some embodiments of the instant disclosure, where the first metal housing is engaged with the second metal housing;

FIG. 16 illustrates a perspective view of the coupling component according to some embodiments of the instant disclosure, where the positioning portion of the coupling body is a round structure;

FIG. 17 illustrates an assembling perspective view of the first metal housing and the coupling component according to some embodiments of the instant disclosure, where the round positioning portion of the coupling body is engaged with the first recess of the first mating portion;

FIG. 18 illustrates a perspective view of the second metal housing according to some embodiments of the instant disclosure, where the second metal housing has a second recess being arced corresponding to the first recess, and a lower surface of the second metal housing comprises stopping blocks;

FIG. 19 illustrates a perspective view of the second metal housing according to some embodiments of the instant disclosure, where the second metal housing has an assembling hole being rectangular corresponding to the second mating portion, and a lower surface of the second metal housing comprises stopping blocks;

FIG. 20 illustrates a perspective view of the second metal housing according to some embodiments of the instant disclosure, where the second metal housing has an assembling hole being rectangular corresponding to the second mating portion, and a lower surface of the second metal housing does not comprise stopping blocks;

FIG. 21 illustrates a perspective view of a pressing member assembled on the first metal housing according to some embodiments of the instant disclosure;

FIG. 22 illustrates an assembling perspective view of the first metal housing and the second metal housing according to some embodiments of the instant disclosure;

FIG. 23 illustrates an assembling perspective view of the first metal housing and the second metal housing according to some embodiments of the instant disclosure, where the stopping blocks are placed across the shoulder portions of the pressing member;

FIG. 24 illustrates an assembling perspective view of the first metal housing and the second metal housing according to some embodiments of the instant disclosure, where the mating protrusions of the first metal housing are aimed at the mating recesses of the second metal housing;

FIG. 25 illustrates an assembled perspective view of the first metal housing and the second metal housing according to some embodiments of the instant disclosure, where the mating protrusions of the first metal housing are mated with the mating recesses of the second metal housing; and

FIG. 26 illustrates a side perspective view of the optical-fiber connector according to some embodiments of the instant disclosure, where the upper surface of the second metal housing is higher than the upper surface of each of the coupling bodies.

### DETAILED DESCRIPTION

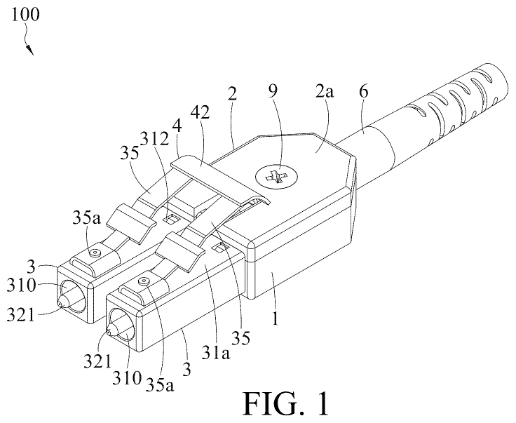

Please refer to FIG. 1. FIG. 1 illustrates a perspective view of an optical-fiber connector 100. In some embodiments, the optical-fiber connector 100 is adapted to be utilized in electrocommunication, interior wiring, industry, military, aerospace, medical devices, or other applications in high-temperature/low-temperature environments, and the optical-fiber connector 100 can be utilized for devices of data center, 5G, cloud computing, or the like. The optical-fiber connector 100 is a high density optical-fiber connection device adapted to provide high speed signal transmission. The optical-fiber connector 100 is a connector for dual-core single-tube tail cap 6. The optical-fiber connector is a product for optical telecommunication and has insertion openings for two optical-fiber cables so as to receive several core wires of the optical-fiber cables (transmission and reception).

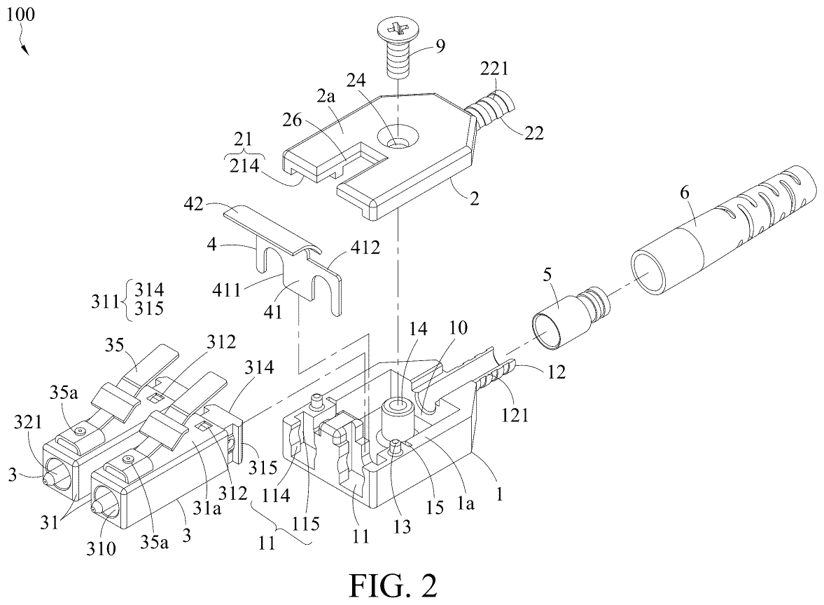

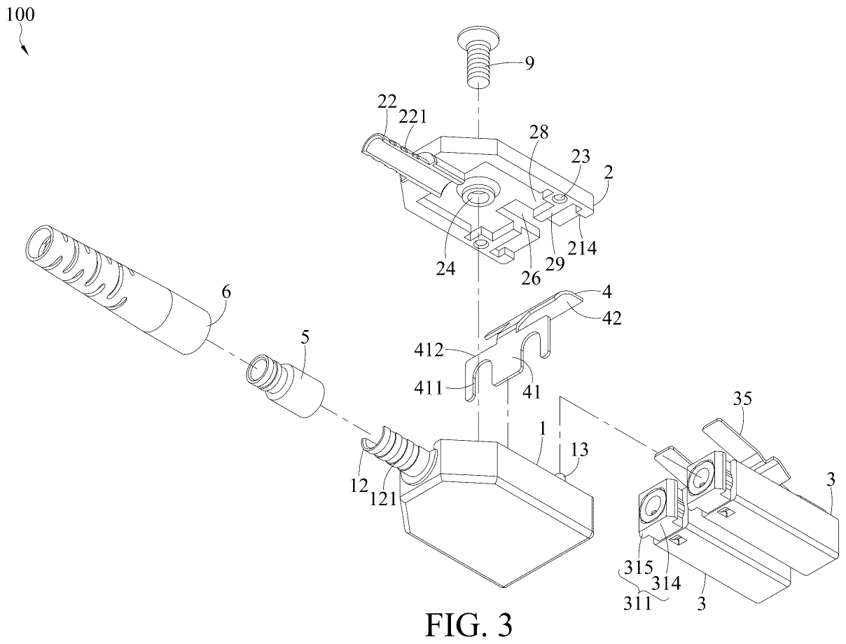

Please refer to FIG. 2 and FIG. 3. FIG. 2 illustrates a front exploded view of the optical-fiber connector 100. FIG. 3 illustrates a rear exploded view of the optical-fiber connector, where the internal elements of the coupling component is not exploded. The optical-fiber connector 100 comprises a first metal housing 1, a second metal housing 2, and a plurality of coupling components 3. The first metal housing 1 has a receiving space 10, one of the two ends of the first metal housing 1 comprises a plurality of first mating portions 11 in communication with the receiving space 10, and the other end of the first metal housing 1 has a first tail cap assembling portion 12. The second metal housing 2 covers the first metal housing 1, one of two ends of the second metal housing comprises a plurality of second mating portions 21 corresponding to the first mating portions 11, and the other end of the second metal housing 2 comprises a second tail cap assembling portion 22 corresponding assembled with the first tail cap assembling portion 12. Each of the coupling components 3 comprises a coupling body 31 and a metal stopping member 35 extending outwards from a surface of the coupling body 31, a side end of each of the coupling bodies 31 comprises a positioning portion 311, and each of the positioning portions 311 is assembled with a corresponding one of the first mating portions 11 and a corresponding one of the second mating portions 21.

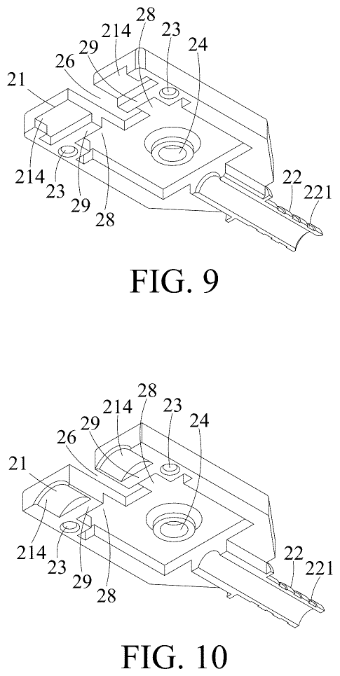

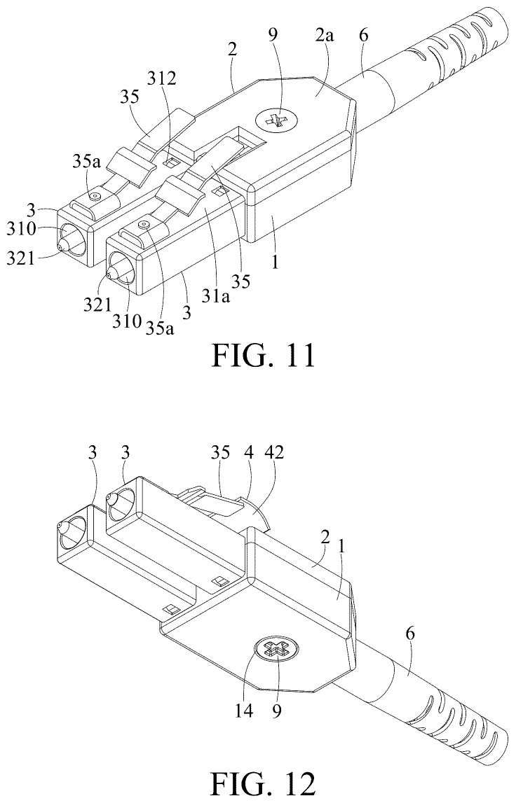

After each of the coupling components 3 is assembled with the first metal housing 1, the second metal housing 2 is then assembled on the first metal housing 1 to cover the positioning portion 311 of each of the coupling component 3 (as shown in FIG. 8, FIG. 9, and FIG. 11). Therefore, according to some embodiments, through the configuration that the first metal housing 1 and the second metal housing 2 are made of metal, the optical-fiber connector 100 can have a robust structure and damages of the connector can be prevented. Hence, the connector can withstand high temperature environments and low temperature environments and thus is applicable for applications in high-temperature/low-temperature environments, and thus the service life of the optical-fiber connector 100 can be extended.

Please refer to FIG. 2 and FIG. 3. In some embodiments, the first tail cap assembling portion 12 of the first metal housing 1 comprises a first semicircle socket structure 121, and the second tail cap assembling portion 22 of the second metal housing 2 comprises a second semicircle socket structure 221. When the first metal housing 1 is assembled with the second metal housing 2, the first semicircle socket structure 121 is mated with the second semicircle socket structure 221, and the first semicircle socket structure 121 and the second semicircle socket structure 221 are assembled as an elongated tubular structure (as shown in FIG. 25), where an outer surface of the elongated tubular structure has a plurality of convex and concave portions. The optical-fiber connector 100 further comprises a compression ring 5 and a tail cap 6. The compression ring 5 is fitted over the first semicircle socket structure 121 and the second semicircle socket structure 221. The compression ring 5 is pressed to contact the convex and concave portions, and the convex and concave portions increase the friction force between the compression ring 5 and the elongated tubular structure, so that the compression ring 5 can be properly fixed on the elongated tubular structure. The tail cap 6 is fitted over the compression ring 5, and the tail cap 6 is an outercoat of the optical-fiber cables.

In some embodiments, the optical-fiber connector 100 comprises two coupling components 3 (as shown in FIG. 1 to FIG. 3), but the instant disclosure is not limited thereto. In some embodiments, the optical-fiber connector 100 may comprise three or more coupling components 3. Here, an embodiment of the optical-fiber connector 100 comprising two coupling components 3 is provided for illustration, the coupling members 3 are side-by-side arranged with each other, each of the coupling members 3 is a rectangular structure, and a gap is between the coupling members 3.

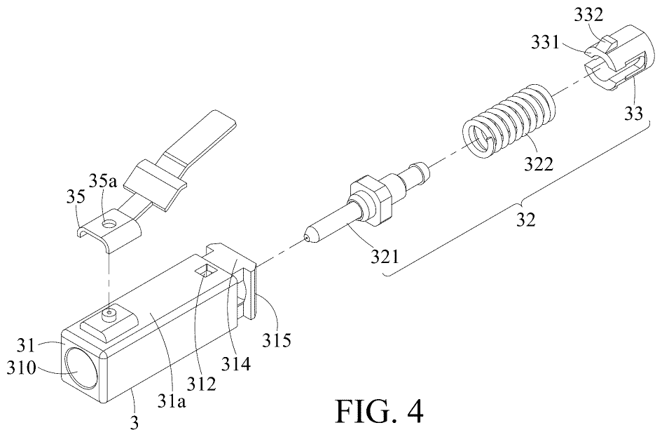

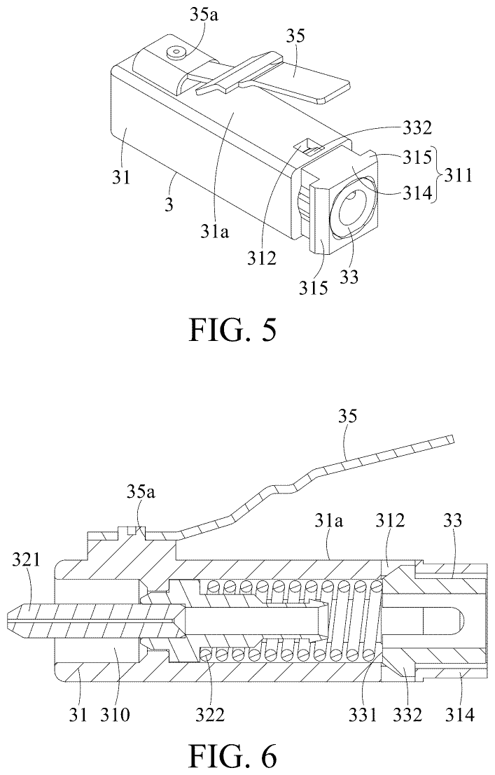

Please refer to FIG. 4 to FIG. 6. FIG. 4 illustrates an exploded view of the coupling component 3. FIG. 5 illustrates a perspective view of the coupling component 3, where the positioning portion 311 of the coupling body 3 is a square structure. FIG. 6 illustrates a cross-sectional view of the coupling body 3. In some embodiments, each of the coupling components 3 comprises a core component 32 and a plug 33. The coupling body 31 has a through hole 310, the core component 32 comprises an insertion pin 321 placed in the through hole 310 and an elastic member 322 fitted over the insertion pin 321. The insertion pin 321 of the core component 32 comprises a core member made of a ceramic material for enclosing optical fiber cables, and the optical fiber cables are aligned with the core hole of the core member.

As shown in FIG. 4 to FIG. 6, in some embodiments, the plug 33 is made of a plastic material or a metal material. The plug 33 comprises two flexible arms 331, each of the flexible arms has a hook portion 332, and the coupling body 31 has a plurality of engaging holes 312 at an inner wall of the through hole 310. When the elastic member 322 is placed in the through hole 310 and one of two ends of the elastic member 322 abuts against the insertion pin 321, the plug 33 is inserted into the through hole 310 from an opening of the through hole 310, so that the plug 33 is placed in the opening of the through hole and abuts against the other end of the elastic member 322. During the process of inserting each of the flexible arms 331 into the corresponding one of the through holes 310, the side end of the flexible arm 331 is compressed by the inner wall of the through hole 310 and is swingable with respect to the through hole 310. Then, the plug 33 is placed in the through hole 310, so that the side end of the flexible arm 331 and the hook portion 332 can be inserted into the through 310. Next, when the hook portion 332 is aimed at the engaging hole 312, the flexible arm 331 is outward bounded toward an opposite direction, so that the hook portion is engaged with the engaging hole 312, and the elastic member 322 is limited in the through hole 310.

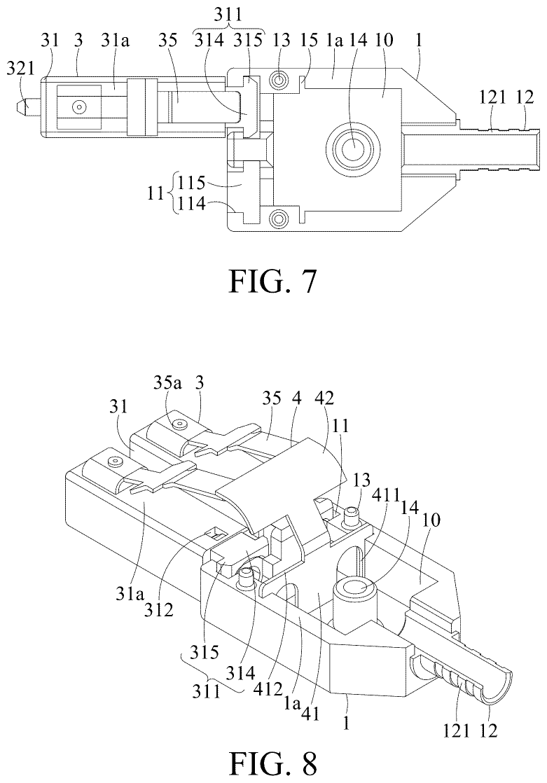

Please refer to FIG. 7 to FIG. 9. FIG. 7 illustrates an assembling perspective view of the first metal housing 1 and the coupling component 2, where the square positioning portion 311 of the coupling body 31 is engaged with the first recess 114 of the first mating portion 111. FIG. 8 illustrates a perspective view of a pressing member 4 assembled on the first metal housing 1. FIG. 9 illustrates a perspective view of the second metal housing 2, where the second metal housing 2 comprises a second locking portion 24 and the second mating portion 21 is rectangular. In some embodiments, the first mating portion 11 comprises a first recess 114 and a first positioning groove 115 at each of two sides of the first recess 114, each of the positioning portions 311 comprises an extension block 314 and a positioning block 315 at each of two sides of the extension block 314, and each of the positioning blocks 315 is engaged with a corresponding one of the first positioning grooves 115. In some embodiments, each of the second mating portions 21 of the second metal housing 2 has a second recess 114 corresponding to the first recess 114 and assembled with the corresponding one of the positioning portions 311 of the coupling component 3.

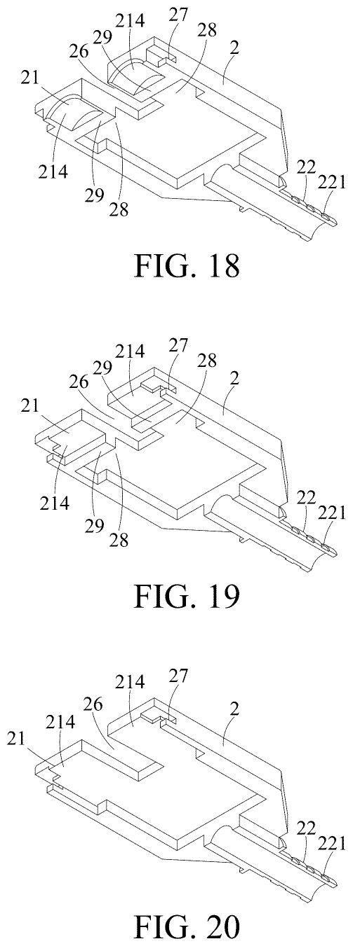

In some embodiments, the first recess 114 is rectangular (as shown in FIG. 2 and FIG. 3) or arced (as shown in FIG. 17). In some embodiments, the second recess 214 is rectangular (as shown in FIG. 2, FIG. 3, FIG. 9, and FIG. 19) or arced (as shown in FIG. 10 and FIG. 18). Take the second recess 214 being a rectangular structure for example, when the second mating portion 21 is assembled with the first mating portion 11, the second recess 214 being rectangular corresponds to the first recess 114 being rectangular, and the second recess 214 of each of the second mating portions 21 is correspondingly engaged with the square extension block 314 of the corresponding one of the coupling bodies 31. Take the second recess 214 being an arced structure for example, when the second mating portion 21 is assembled with the first mating portion 11, the second recess 214 being arced corresponds to the first recess 114 being arced, and the second recess 214 of each of the second mating portions 21 is correspondingly engaged with the round extension block 314 of the corresponding one of the coupling bodies 31.

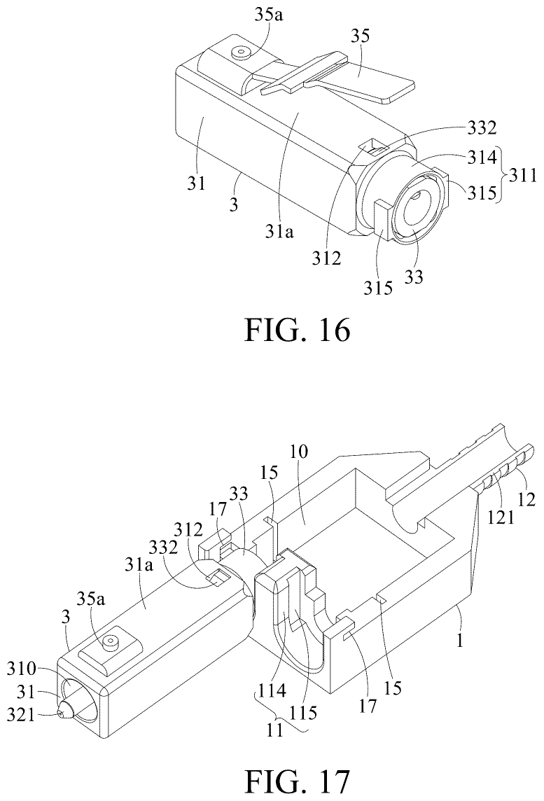

In some embodiments, the extension block 314 may be a square structure (as shown in FIG. 3 and FIG. 5) or a round structure (as shown in FIG. 16 and FIG. 17). Take the extension block 314 being a square structure as an example, when the extension block 314 of each of the coupling bodies 31 is assembled with the corresponding one of the corresponding one of the first recesses 114 of the first metal housing 1, the square extension block 314 is correspondingly engaged with the first recess 114 being rectangular (as shown in FIG. 7 and FIG. 8). Take the extension block 314 being a round structure as an example, when the extension block 314 of each of the coupling bodies 31 is assembled with the corresponding one of the corresponding one of the first recesses 114 of the first metal housing 1, the round extension block 314 is correspondingly engaged with the first recess 114 being arced (as shown in FIG. 16 and FIG. 17).

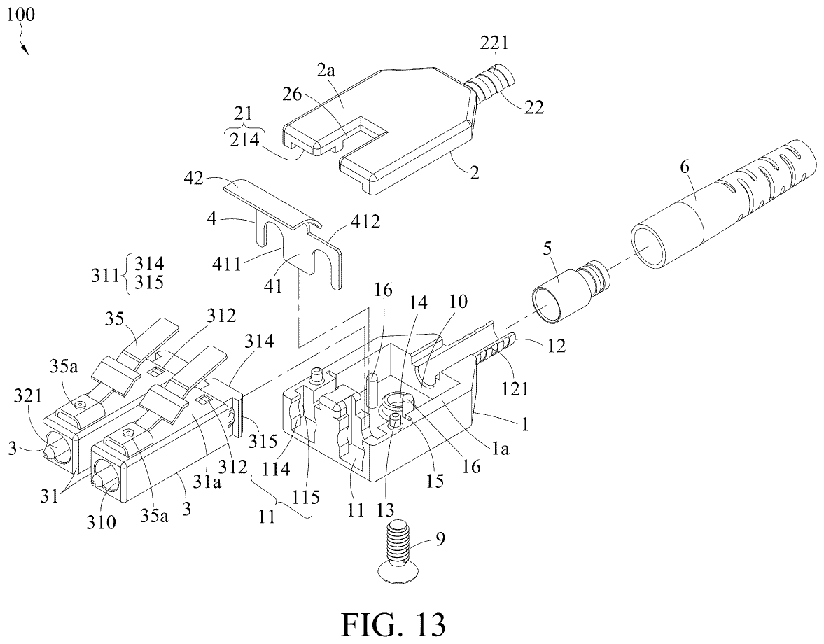

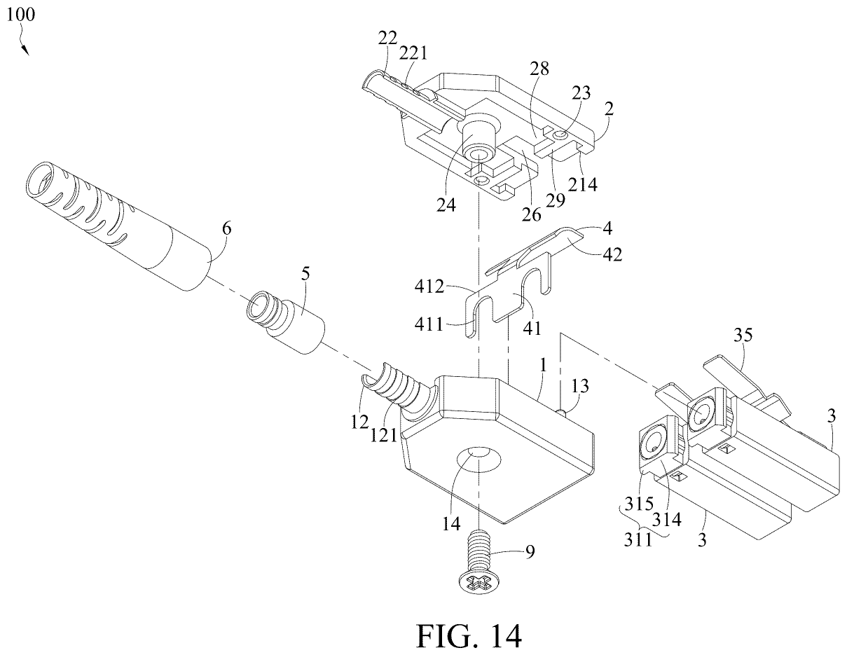

Please refer to FIG. 8, FIG. 9, and FIG. 11. FIG. 11 illustrates a perspective view of the optical-fiber connector 100, where the second metal housing 2 comprises a second locking portion 24 and the optical-fiber connector 100 does not comprises a pressing member 4. In some embodiments, the first metal housing 1 and the second metal housing 2 can be assembled with each other through locking, but the instant disclosure is not limited thereto. Take the locking manner as an example, each of two sides of the first metal housing 1 has a positioning post 13, the first metal housing 1 comprises a first locking portion 14 in the receiving space 10, each of two sides of the second metal housing 2 has a positioning hole 23, and the second metal housing 2 comprises a second locking portion 24. When the second metal housing 2 covers the first metal housing 1, each of the positioning posts 13 is mated with the corresponding one of the positioning holes 23, and the first locking portion 14 is mated with the second locking portion 24. The first locking portion 14 is configured as a locking hole at an upper surface of the first metal housing 1, a screw 9 is locked into the locking hole at the upper surface of the first metal housing 1, so that the first metal housing 1 and the second metal housing 2 can be locked with each other. Please refer to FIG. 12, FIG. 13, and FIG. 14. In some embodiments, the second locking portion 24 is configured as a locking hole at a lower surface of the second metal housing 2, a screw 9 is locked into the locking hole at the lower surface of the second metal housing 2, so that the first metal housing 1 and the second metal housing 2 can be locked with each other; since the screw 9 is exposed from the lower surface of the second metal housing 2 which cannot be seen obviously, thereby achieving a neat appearance. In some embodiments, the first metal housing 1 and the second metal housing 2 are made of zinc alloy material.

Please refer to FIG. 12, FIG. 13, and FIG. 14. FIG. 12 illustrates a rear perspective view of the optical-fiber connector 100, where the first metal housing 1 comprises a first locking portion 14 and a screw 9 is locked to the first locking portion 14. FIG. 13 illustrates a front exploded view of the optical fiber connector 100, where the first metal housing 1 comprises a first locking portion 14 and the first metal housing 14 has a plurality of partition portions 16 in the receiving space 10. FIG. 14 illustrates a rear exploded view of the optical-fiber connector 100, where the first metal housing 1 comprises a first locking portion and the first metal housing has a plurality of partition portions 16 in the receiving space 10. In some embodiments, the first metal housing 1 comprises a plurality of partition portions 16 in the receiving space 10, and the partition portions 16 are at the two sides of the first locking portion 14. When two optical-fiber cables are installed in the receiving space 10, each of the optical-fiber cables is limited between a corresponding one of the partition portions 16 and a corresponding one of two side walls 1a at the two sides of the first metal housing 1, so that the optical-fiber cables are not arranged too close to the first locking portion 14. Therefore, when the first locking portion 14 is mated with the second locking portion 24, the condition that the optical-fiber cables are pressed and thus cut by the second locking portion 24 of the second metal housing 2 can be prevented.

Please refer to FIG. 2, FIG. 3, FIG. 7, and FIG. 8. In some embodiments, the optical-fiber connector 100 further comprises a pressing member 4 (the pressing member 4 may be also omitted, as described later). The second metal housing 2 has an assembling hole 26, the pressing member 4 has a partition plate 41 and a pressing portion 42, the pressing portion 42 is a curved flexible piece, and the partition plate 41 and the pressing member 42 are integrally formed as a one-piece structure. Each of the two side walls 1a of the first metal housing 1 has an engaging groove 15. When the optical-fiber cable (core cable) is disposed in the receiving space 10 of the first metal housing 1, the partition plate 41 of the pressing member 4 is assembled in the receiving space 10 of the first metal housing 1, and two ends of the partition plate 41 are respectively engaged with the engaging grooves 15. Then, the second metal housing 2 is covered on the first metal housing 1, and the pressing portion 42 is exposed from the assembling hole 26 of the second metal housing 2 and abuts against the metal stopping members 35. In some embodiments, two coupling components 3 are cooperated with one pressing member 4, but the instant disclosure is not limited thereto; in some embodiments, one coupling component 3 is cooperated with one pressing member 4, or three or more coupling components 3 are cooperated with one pressing member 4.

Please refer to FIG. 2, FIG. 3, FIG. 7, and FIG. 8. In some embodiments, the partition plate 41 of the pressing member 4 has a plurality of slots 411 corresponding to the first mating portions 11, and each of the slots 411 is an inversed U-shaped structure and has an opening. When the two ends of the partition plate 41 are assembled with the engaging grooves 15, the two optical-fiber cables in the receiving space 10 are respectively placed into the slots 411 through the openings of the slots 411. Therefore, through the configuration that each of the slots 411 is an inversed U-shaped structure to have an opening, the optical-fiber can be assembled with the optical-fiber connector 100 conveniently.

Please refer to FIG. 2, FIG. 3, FIG. 7, and FIG. 8. In some embodiments, the thickness of the pressing member 4 is reduced to ensure the flexibility of the pressing portion 42, so that the pressing portion 42 can be pressed conveniently. Under the configuration that the thickness of the pressing member 4 is reduced, the partition plate 41 has a predetermined wall between the slots 411, and the predetermined wall has a predetermined thickness to ensure the structural strength of the pressing member 4. The depth of the slots 411 of the partition plate 41 may be increased, so that a top portion of each of the slots 411 of the partition plate 41 of the pressing member 4 (the inner curved portion shown in FIG. 8) is adjacent to a top portion of a corresponding one of the two side walls 1a of the first metal housing 1. Therefore, during assembling the pressing member 4 with the optical-fiber cables, the condition that the inner wall of each of the slots 411 scratches the optical-fiber cable to break the optical-fiber cable can be prevented. Moreover, since the depth of the slots 411 of the partition plate 41 is increased, each of the two ends of the partition plate 41 has a shoulder portion 412 above the slots 411. When the two ends of the partition plate 41 are assembled with the engaging grooves 15 at the two side walls 1a of the first metal housing 1, each of the shoulder portions is exposed from a corresponding one of the engaging grooves 15 and is at the top portion of each of the two side walls 1a of the first metal housing 1.

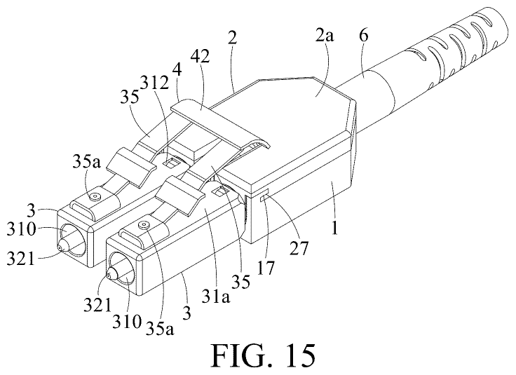

Please refer to FIG. 15, FIG. 17, and FIG. 18. FIG. 18 illustrates a perspective view of the second metal housing 2, where the second metal housing 2 has a second recess 214 being arced corresponding to the first recess 114, and the lower surface of the second metal housing 2 comprises stopping blocks 29. In some embodiments, the first metal housing 1 and the second metal housing 2 can be assembled with each other through engaging, but the instant disclosure is not limited thereto. Take the engaging manner as an example, each of the two sides of the first metal housing 1 has a mating protrusion 17, and each of two sides of the second metal housing 2 has a mating recess 27. The second metal housing 2 is covered on the first metal housing 1 and is moved laterally with respect to the first metal housing 1, so that each of the mating protrusions a17 is mated with the corresponding one of the mating recesses 27.

Please refer to FIG. 15, FIG. 17, and FIG. 18. In some embodiments, the lower surface of the second metal housing 2 has a plurality of limiting grooves 28, and the lower surface of the second metal housing 2 comprises a plurality of stopping blocks 29 (the stopping blocks 29 may be omitted, as described later). Each of the stopping blocks 29 is between a corresponding one of the second mating portions 21 and a corresponding one of the limiting grooves 28.

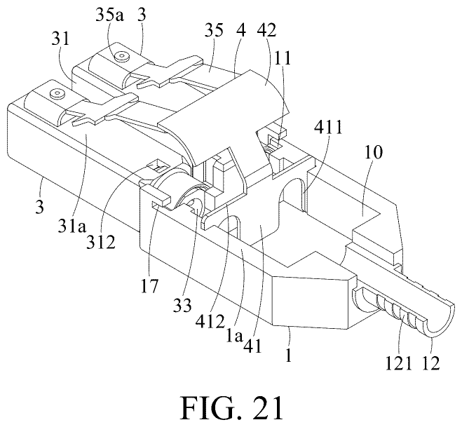

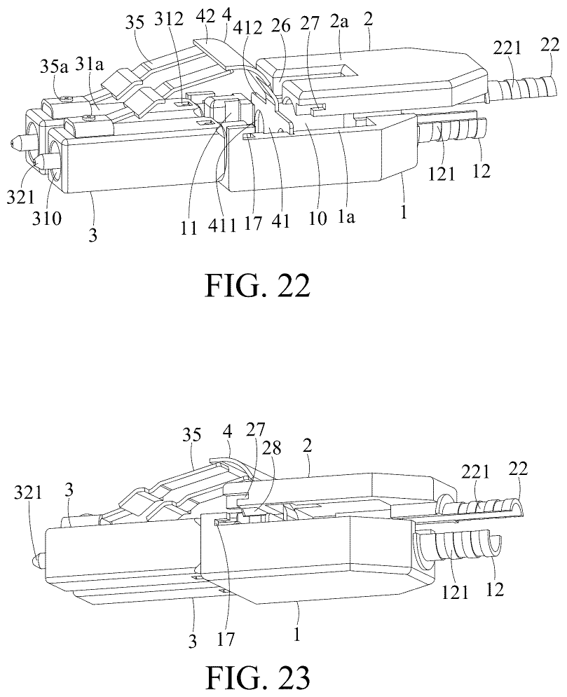

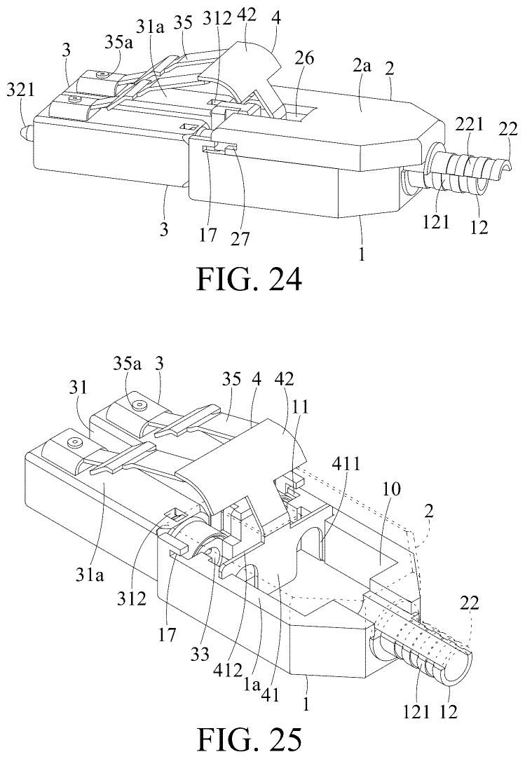

Please refer to FIG. 21 to FIG. 25. FIG. 21 illustrates a perspective view of a pressing member 4 assembled on the first metal housing 1. FIG. 22 illustrates an assembling perspective view of the first metal housing 1 and the second metal housing 2. FIG. 23 illustrates an assembling perspective view of the first metal housing 1 and the second metal housing 2, where the stopping blocks 29 are placed across the shoulder portions 412 of the pressing member 4. FIG. 24 illustrates an assembling perspective view of the first metal housing 1 and the second metal housing 2, where the mating protrusions 17 of the first metal housing 1 are mated with the mating recesses 27 of the second metal housing 2. In some embodiments, when the second metal housing 2 is to be assembled on the first metal housing 1, the stopping blocks 29 of the second metal housing 2 are placed across the shoulder portion 412 of the pressing member 4, so that each of the limiting grooves 28 is aimed at the corresponding one of the shoulder portions 412 of the pressing member 4, and the second metal housing 2 is covered on the first metal housing 1. Next, the second metal housing 2 is moved laterally with respect to the first metal housing, so that each of the mating protrusions 28 is mated with the corresponding one of the mating recesses 27, and each of the shoulder portions 412 of the pressing member 4 is engaged with the corresponding one of the limiting groove 28. Accordingly, the assembling of the first metal housing 1 and the second metal housing 2 can be achieved.

Please refer to FIG. 20. FIG. 20 illustrates a perspective view of the second metal housing 2, where the second metal housing 2 has an assembling hole 26 being rectangular corresponding to the second mating portion 221, and a lower surface of the second metal housing 2 does not comprise stopping blocks 29. In some embodiment, the lower surface of the second metal housing 2 does not comprises stopping blocks 29 (that is, the stopping blocks 29 as shown in FIG. 19 is omitted). When the second metal housing 2 is to be assembled on the first metal housing 1, the second metal housing 2 is covered on the first metal housing 1. Next, the second metal housing 2 is moved laterally with respect to the first metal housing, so that each of the mating protrusions 28 is mated with the corresponding one of the mating recesses 27, and each of the shoulder portions 412 of the pressing member 4 is engaged with the corresponding one of the limiting groove 28. Accordingly, the assembling of the first metal housing 1 and the second metal housing 2 can be achieved easily.

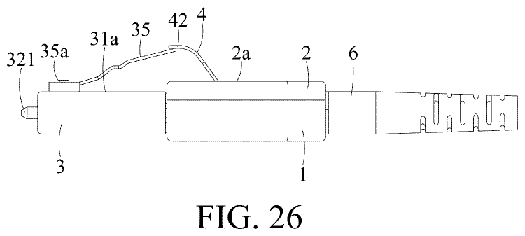

Please refer to FIG. 26. FIG. 26 illustrates a side perspective view of the optical-fiber connector 100, where the upper surface of the second metal housing 2 is higher than the upper surface of each of the coupling bodies 31. In some embodiments, the upper surface of each of the coupling bodies 31 has a first horizontal plane 31a, the upper surface of the second metal housing 2 has a second horizontal plane 2a, for each of the coupling components 3, the metal stopping member 35 has a fulcrum 35a connected to the surface of the coupling body 31, the second horizontal plane 2a and the fulcrum 35a are at the same horizonal line, and the second horizontal plane 2a is higher than the first horizontal plane 31a and is adjacent to a side end of the metal stopping member 35. When the pressing member 42 is pressed to drive the metal stopping member 35 to swing, the side end of the metal stopping member 35 is moved toward the second horizontal plane 2a, and the side end of the metal stopping member 35 is adapted to lean against the second horizontal plane 2a. because the side end of the metal stopping member 35 leans against the second horizontal plane 2a which is higher than the first horizontal plane 31a, the condition that the deformation of the metal stopping member 35 caused by excessive swinging movement of the side end of the metal stopping member 35 can be prevented, and the condition that the side end of the metal stopping member 35 fails to move to the original position resiliently can be prevented.

According to some embodiments of the instant disclosure, through the configuration that the first metal housing and the second metal housing are made of metal, the optical-fiber connector can have a robust structure and damages of the connector can be prevented, thereby extending the service life of the optical-fiber connector. Moreover, according to some embodiments, the plug is fixed with the through hole of the coupling body and abuts against the elastic member, so that the elastic member can be properly limited within the through hole. Furthermore, according to some embodiments, several types of combinations among the coupling body, the first metal housing, and the second metal housing or combinations between the first metal housing and the second metal housing can be achieved, thereby the optical-fiber connector can be utilized in different applications.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An optical-fiber connector, comprising:
a first metal housing having a receiving space, wherein one of two ends of the first metal housing comprises a plurality of first mating portions in communication with the receiving space, and the other end of the first metal housing has a first tail cap assembling portion;
a second metal housing covering the first metal housing, wherein one of two ends of the second metal housing comprises a plurality of second mating portions corresponding to the first mating portions, and the other end of the second metal housing comprises a second tail cap assembling portion correspondingly assembled with the first tail cap assembling portion; and
a plurality of coupling components, wherein each of the coupling components comprises a coupling body and a metal stopping member extending outwards from a surface of the coupling body, a side end of each of the coupling bodies comprises a positioning portion, and each of the positioning portions is assembled with a corresponding one of the first mating portions and a corresponding one of the second mating portions.

2. The optical-fiber connector according to claim 1, wherein each of the coupling components comprises a core component and a plug, the coupling body has a through hole, the core component is in the through hole, the plug comprises two flexible arms, each of the flexible arms has a hook portion, the coupling body has a plurality of engaging holes at an inner wall of the through hole, each of the flexible arms is placed in the through hole, and each of the hook portions is engaged with a corresponding one of the engaging holes; for each of the coupling components, the core component comprises an insertion pin and an elastic member fitted over the insertion pin, and the plug is at an opening of the through hole and abuts against the elastic member.

3. The optical-fiber connector according to claim 1, wherein each of the first mating portions has a first recess and a first positioning groove at each of two sides of the first recess, each of the positioning portions comprises an extension block and a positioning block at each of two sides of the extension block, and each of the positioning blocks is engaged with a corresponding one of the first positioning grooves; the first recess is rectangular or arced, in response to that the first recess is rectangular, the extension block is a square structure corresponding to the first recess being rectangular; in response to that the first recess is arced, the extension block is a round structure corresponding to the first recess being arced.

4. The optical-fiber connector according to claim 3, wherein each of the second mating portions has a second recess corresponding to the first recess and assembled with the corresponding one of the positioning portions; the second recess is rectangular or arced, in response to that the first recess is rectangular, the second recess is rectangular corresponding to the first recess being rectangular; in response to that the first recess is arced, the second recess is arced corresponding to the first recess being arced.

5. The optical-fiber connector according to claim 1, wherein each of two sides of the first metal housing has a positioning post, the first metal housing comprises a first locking portion in the receiving space, each of two sides of the second metal housing has a positioning hole, the second metal housing comprises a second locking portion, each of the positioning posts is mated with a corresponding one of the positioning holes, and the first locking portion is mated with the second locking portion; the first metal housing comprises a plurality of partition portions in the receiving space, and the partition portions are at the two sides of the first locking portion.

6. The optical-fiber connector according to claim 1, further comprising a pressing member, wherein the pressing member has a partition plate and a pressing portion, each of two side walls at two sides of the first metal housing has an engaging groove, two ends of the partition plate are respectively engaged with the engaging grooves, the partition plate has a plurality of slots corresponding to the first mating portions, a top portion of each of the slots is adjacent to a top portion of a corresponding one of the two side walls of the first metal housing, and each of the two ends of the partition plate has a shoulder portion exposed from a corresponding one of the engaging grooves; the second metal housing has an assembling hole, and the pressing portion is exposed from the assembling hole and abuts against the metal stopping members.

7. The optical-fiber connector according to claim 6, wherein each of the two sides of the first metal housing has a mating protrusion, each of two sides of the second metal housing has a mating recess, each of the mating protrusions is mated with a corresponding one of the mating recesses, a lower surface of the second metal housing has a plurality of limiting grooves, and each of the shoulder portions of the pressing member is engaged with a corresponding one of the limiting grooves.

8. The optical-fiber connector according to claim 7, wherein the lower surface of the second metal housing comprises a plurality of stopping blocks, and each of the stopping blocks is between a corresponding one of the second mating portions and a corresponding one of the limiting grooves.

9. The optical-fiber connector according to claim 1, wherein the first tail cap assembling portion comprises a first semicircle socket structure, the second tail cap assembling portion comprises a second semicircle socket structure, the first semicircle socket structure is mated with the second semicircle socket structure, the optical-fiber connector further comprises a compression ring and a tail cap, the compression ring is fitted over the first semicircle socket structure and the second semicircle socket structure, and the tail cap is fitted over the compression ring.

10. The optical-fiber connector according to claim 1, wherein for each of the coupling components, an upper surface of the coupling body has a first horizontal plane, an upper surface of the second metal housing has a second horizontal plane, the second horizontal plane is higher than the first horizontal plane and adjacent to a side end of the metal stopping member, and the side end of the metal stopping member is adapted to lean against the second horizontal plane.
